(19) United States
(12) Patent Application Publication
(10) Pub. No.: US 2007/0127383 A1
(43) Pub. Date: Jun. 7, 2007

(54) Accounting information filtering method and apparatus

(75) Inventor: Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc., Alameda, CA (US)

(21) Appl. No.: 11/295,356

(22) Filed: Dec. 6, 2005

(51) Int. Cl. H04L 12/26

(52) U.S. Cl. 370/241; 709/224; 370/401

(57) ABSTRACT

A network element receives data intended for another destination and develops corresponding accounting information. This network element then process this accounting information with respect to at least one filter criterion as correlates to a target accounting information recipient to provide corresponding filtered accounting information. The network element then forwards this filtered accounting information to the target accounting information recipient.

### TECHNICAL FIELD

This invention relates generally to communication systems and more particularly to the handling of accounting information.

### BACKGROUND

Communication systems of various kinds are known in the art. Many such systems support the conveyance of data using so-called packet data. It can be important in many systems to develop accounting information as corresponds to data traffic in order to appropriately bill system users. Remote Authentication Dial-In User Service (RADIUS) comprises a well known authentication, authorization, and accounting (AAA) protocol to support such activity.

In a typical RADIUS-based configuration an access gateway performs accounting procedures with respect to each system user's data traffic. These procedures can comprise, for example, noting and reporting information regarding byte counts (during both uplink and downlink activity), flow-level byte counts, client identification (including but not limited to hardware identifiers, software identifiers, Network Access Identifiers (NAI), Internet Protocol addresses, and so forth), session duration, and/or access-technology-specific information, to note but a few examples.

RADIUS accounting messages are typically of the request/response type. For example, the access gateway will typically periodically send an accounting record to an accounting server and the latter will respond with an acknowledgement. RADIUS-based accounting supports the use of so-called mirror groups. So configured, multiple accounting servers can comprise a mirror group and a corresponding access gateway will send a copy of each accounting record to each of the accounting servers in the mirror group. Such an approach assures redundant storage of all accounting information and therefore aids in ensuring that such information will likely be and remain available for subsequent use.

Supporting a mirror group in this fashion, of course, can consume considerable network resources. Network administrators typically accept this burden as being necessary to ensure the redundant capture and storage of this accounting information. There are circumstances, however, when such an approach does not accord well with the needs of a given application setting.

As but one simple example, a maintenance organization for a given communication network may need access from time to time to accounting information in order to confirm network operations or to diagnose network problems. Due to the important (even critical) nature of accounting information to the business of operating a communication system, however, such a maintenance organization may have trouble gaining the desired access to conduct such activities. At the same time, the maintenance organization may be disinclined to establish its own accounting server for such purposes as the network burden of supporting the corresponding accounting information traffic may be viewed as being relatively high as compared to the value of having improved access to such information.

### BRIEF DESCRIPTION OF THE DRAWINGS

The above needs are at least partially met through provision of the accounting information filtering method and apparatus described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a network element receives data intended for another destination and develops corresponding accounting information. This network element then process this accounting information with respect to at least one filter criterion as correlates to a target accounting information recipient to provide corresponding filtered accounting information. The network element then forwards this filtered accounting information to the target accounting information recipient.

As suggested above, a plurality of filter criteria can be employed if desired to limit in a desired fashion the scope of the resultant filtered accounting information. Also if desired, multiple filter criteria can be used with different corresponding target accounting information recipients to thereby permit the development of differing corresponding resultant filtered accounting information results.

So configured, the filtered accounting information can be forwarded by the network element without necessarily unduly burdening communication system resources. At the same time, this more limited selection of accounting information can be sufficient to facilitate the studies that a maintenance organization (or others) might be expected to conduct. Accordingly, those skilled in the art will recognize and appreciate that these teachings tend to improve the flexibility by which various accounting-information related tasks can be carried out without unduly burdening the resources and capabilities of a corresponding communication system.

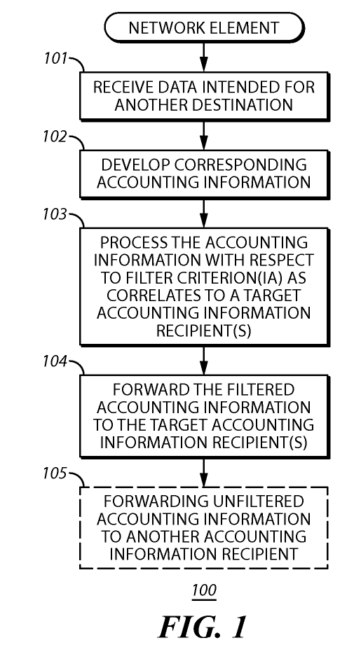

These and other benefits may become clearer upon making a thorough review and study of the following detailed description. Referring now to the drawings, and in particular to FIG. 1, these teachings may be deployed using a network element of choice. Exemplary network elements include, but are not limited to, Packet Data Serving Nodes (PDSN's), wireless home agents, Gateway General Packet Radio Service Support Nodes (GGSN's), 802.11-family compatible access gateways, Digital Subscriber Line (DSL) access multipliers, and remote access servers, to note but a few. (Those skilled in the art will recognize and understand that such a network element can comprise a single integrated platform or can be distributed over a plurality of enabling platforms.)

Pursuant to these teachings and via a corresponding process 100 such a network element receives 101 data (such as, but not limited to, data packets as are known in the art) that is intended for another destination. Such data may be sourced by, for example, an end user of a wireless communication system and can comprise any bearer data including but not limited to files, voice, multimedia content, and so forth. Various kinds of data are known in the art as are various conveyance protocols. In addition, the present teachings are not particularly sensitive to the selection of any particular approach in this regard. Accordingly, for the sake of brevity, further elaboration regarding such data or the reception of such data need not be presented here.

This process 100 then provides for developing 102 accounting information as corresponds to the received data. Such accounting information can relate, for example, to the quantity of data, the type of data, the time of receiving the data, the source and/or ultimate destination of the data, a quality of service to be provided with respect to conveying the data, identity of the client device, a physical or topological location of the client device, one or more network addresses as are associated with the client device, pre-paid billing information, and so forth. Various kinds of accounting information are presently known and other kinds of accounting information will likely be developed in the future. Furthermore, once again, these teachings are not reliant upon any particular means of developing such accounting information. Accordingly, and again for the sake of brevity, additional information regarding developing such accounting information need not be provided here.

This process 100 next processes 103 this accounting information with respect to at least one filter criterion as correlates to a target accounting information recipient to provide filtered accounting information. This target accounting information recipient will vary with the needs and/or requirements of a given application setting but will typically not comprise a standard accounting server that operates as an ordinary member of a mirror group. Instead, the primary intent here is to support providing a reduced amount of accounting information to the target accounting information recipient whereas an ordinary mirror group accounting server will more usually be intended to receive all such available accounting information in order to serve as an effective redundant storage venue.

The specific filter criterion (or criteria) employed for such purposes will of course vary with the application setting. Exemplary criteria include, but are not limited to:

a Network Access Identifier as corresponds to a source of the data;

a Network Access Identifier as corresponds to the another destination;

a domain identifier;

an International Mobile Station Identity;

an Electronic Serial Number;

a Mobile Equipment IDentifier;

a client device Internet Protocol address;

a Home Agent Internet Protocol address;

a Packet Control Function Internet Protocol address;

a base station identifier;

a service option; and/or

a quality of service indicator.

As noted, only a single filter criterion may be employed in a given setting to achieve a desired filtered result. In many instances, however, it may be useful to employ a plurality of filter criteria as correlates to the target accounting information recipient. Using multiple filter criteria can serve, for example, to more specifically winnow down the items of candidate accounting information to a relatively small group. By one approach, such a plurality of filter criteria could be combined using conjunctive Boolean expressions such as AND, OR, NOR, BUT NOT, and so forth to achieve the desired filtering effect.

It would also be possible to condition the application of one or more filter criteria (or filters) with respect to some predetermined event. As but one example, a given filter criteria might remain unused unless and until a specific data source transmitted more than a given number of bytes of data within a predetermined period of time.

This process step 103 can also serve the needs of more than a single target accounting information recipient. To illustrate, if desired, this step can comprise processing the accounting information with respect to at least one first filter criterion as correlates to a first target accounting information recipient to provide first filtered accounting information and also processing this same accounting information with respect to at least one second filter criterion as correlates to a second target accounting information recipient to provide corresponding second filtered accounting information. Any number of other target accounting information recipients can be similarly accommodated as may be desired or useful in a given application setting.

This process 100 then provides for forwarding 104 the filtered accounting information to the target information recipient. This action more particularly comprises not forwarding all of the accounting information to the target information recipient but rather sending only (or substantially only) the filtered accounting information. Accordingly, if the filtering process reduces the candidate accounting information to only, say, 0.5% of the original total amount, then essentially only this substantially reduced amount is forwarded to the target information recipient.

When multiple groups of filtered accounting information are formed as suggested above, this step of forwarding 104 the filtered accounting information can comprise forwarding the filtered accounting information for each corresponding targeted recipient. To illustrate, and continuing with the example presented above where first and second filtered accounting information is developed for a first and second target accounting information recipient, this step 104 can comprise forwarding the first filtered accounting information to the first target accounting information recipient and forwarding the second filtered accounting information to the second target accounting information recipient.

Various forwarding techniques are known in the art. By one approach such filtered accounting information can be sent upon becoming available such that this information is essentially immediately forwarded. By another approach such filtered accounting information is forwarded using batching techniques. By this approach the filtered accounting information may be combined with other previously (or subsequently) developed information or content prior to being forwarded to the target recipient.

By the teachings set forth above a given quantity of accounting information is effectively filtered to provide a reduced set of accounting information that is then forwarded to a given target accounting information recipient. Those skilled in the art will appreciate that such teachings may be compatibly employed in conjunction with more traditional mirror group forwarding behaviors. For example, and with continued reference to FIG. 1, if desired this process 100 can optionally provide for also forwarding 105 the aforementioned accounting information without filtering to another accounting information recipient (other than the target accounting information recipient that receives a filtered set of accounting information).

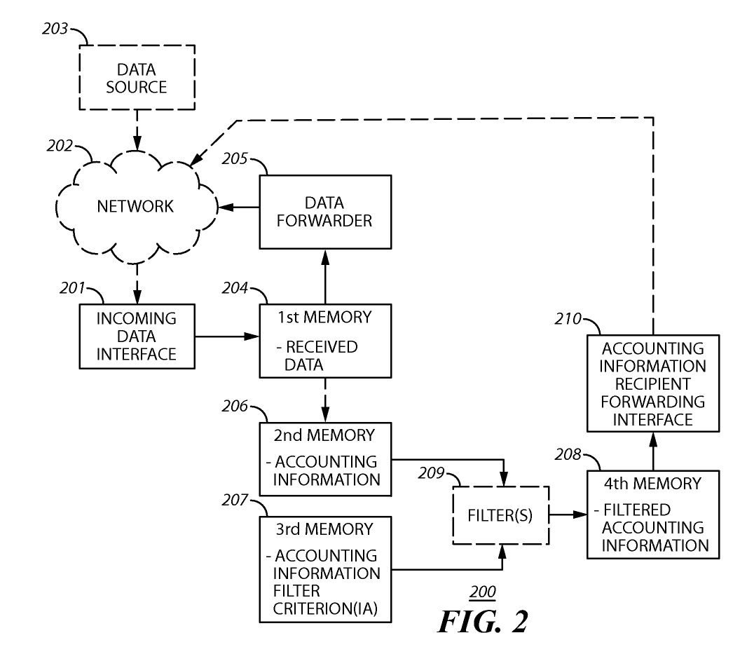

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

The disclosed apparatus 200 may comprise a network element as suggested above having an incoming data interface 201. This incoming data interface 201 may operably couple to a network 202 of choice (such as an intranet or extranet (such as the Internet) as are known in the art). So configured, the incoming data interface 201 may receive data from a data source 203 (such as an end user platform of choice) via the network 202 using means and methods that are well understood in the art.

This illustrative apparatus 200 further comprises a first memory 204 that operably couples to the incoming data interface 201 and that stores (at least temporarily) received data prior to forwarding that data on to an intended destination via, for example, a corresponding data forwarder 205. As noted above, such received and stored data can comprise data packets of various types and lengths and containing content of various types. In many cases this first memory 204 may essentially serve a buffering purpose that supports a data forwarding role of the apparatus 200.

This embodiment further comprises a second memory 206 having accounting information as corresponds to the received data stored therein and has been generally described above. Those skilled in the art will understand that various ways and means exist to develop accounting information of choice with respect to the receipt, forwarding, and handling of such data packets. Accordingly, further details regarding a particular means-of developing such accounting information is not described here.

A third memory 207 contains one or more accounting information filter criterion stored therein. Illustrative examples of such criterion were provided above and those skilled in the art will recognize and appreciate that various combinations of these or other criteria of interest may be employed in a given application setting to obtain a desired filtered result. Also in accord with the teachings set forth herein this third memory 207 can store at least some accounting information filter criteria as corresponds to a first target accounting information recipient and at least some accounting information filter criteria as corresponds to a second (or beyond) target accounting information recipient.

A fourth memory 208 stores filtered accounting information. More particularly, this filtered accounting information comprises accounting information that has been filtered with respect to at least one of the aforementioned accounting information filter criterion. By one optional approach such filtered accounting information can be formed using a filter (or filters) 209 that operably couples to the second, third, and fourth memories 206, 207, and 208 and that processes the accounting information as provided by the second memory 206 with respect to selected relevant filter criteria as provided by the third memory 207. By one approach, such relevance arises as a function, at least in part, of the target accounting information recipient for which the filtering activity is being undertaken.

The fourth memory 208 then, in this illustrative embodiment, operably couples to an accounting information recipient forwarding interface 210 that serves, for example, through appropriate configuration and arrangement to forward the filtered accounting information to a corresponding target accounting information recipient. As noted above, in a given instance a first set of filtered accounting information may be developed for a first accounting information recipient and additional sets of filtered accounting information may be developed for other corresponding accounting information recipients. In such an instance, if desired, this accounting information recipient forwarding interface 210 can be configured and arranged to forward such sets of filtered accounting information to appropriate corresponding recipient accounting information recipients.

So configured, such a network element can readily support the teachings set forth herein. In particular, such a network element is readily able to flexibly and reliably filter data packet-related accounting information with respect to useful filter criteria to thereby yield a reduced set of accounting information that is then forwarding to a corresponding recipient platform. Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements (such as, but not limited to, the various depicted memories) can be enabled and realized via a shared platform. It will also be understood that such a shared platform may comprise a wholly or at least partially programmable platform as are known in the art.

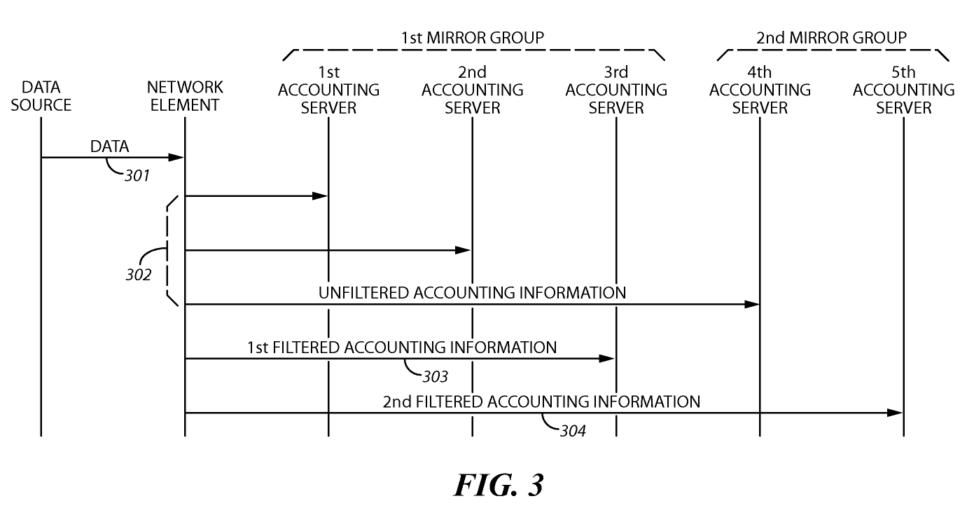

These teachings can be implemented and leveraged in a wide variety of ways. For purposes of illustration and not by way of limitation, and referring now to FIG. 3, a simple example will be provided. In this example, a data source (such as an end user platform) provides data 301 to a network element such as a Packet Data Serving Node. In this example this data comprises data packets that include a destination address other than the network element. Before forwarding these data packets towards that destination, this network element takes action as described above to develop accounting information as corresponds to such data packets.

As per usual practice in this regard, this network element then forwards that accounting information 302 in unfiltered form to a first and second accounting server as comprise a part of a first mirror group and to a fourth accounting server as comprises a part of a second mirror group. (Multiple mirror groups are typically employed to support various purposes. By one example, a first mirror group may exist to receive accounting records as correspond to end user client devices that are registered with a first domain while a second mirror group may serve to receive accounting records as correspond to end user client devices that are registered with a second, different domain.)

As per these teachings, this network element has also filtered the accounting information with respect to a first filter criterion (or criteria) as corresponds to a third accounting server as comprises a part of the first mirror group to provide a first set of filtered accounting information 303 which the network element forwards to this third accounting server. Similarly, in this example, this network element has also filtered the accounting information with respect to a second filter criterion (or criteria) as corresponds to a fifth accounting server as comprises a part of the second mirror group to provide a second set of filtered accounting information 304 which the network element forwards to this fifth accounting server.

So configured, these teachings readily permit, for example, an operations department having physical network equipment management responsibility to filter and forward only limited accounting information in order to facilitate, for example, debugging activities. Access to such accounting records, even though considerably limited as compared to a non-filtered accounting information recipient, can be used to determine, for example, whether a given device is able to connect to the network, the geographical and/or logical point of network attachment that a given device is using, whether a given device is currently engaged in a communication session, whether a given device is able to both transmit and receive data, and so forth.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example, some of the above-presented examples made reference to RADIUS accounting procedures. Those skilled in the art will readily appreciate, however, that these teachings are generally applicable and may be deployed for use with other accounting protocols such as, but not limited to, the DIAMETER accounting protocol. As another example, if desired, the ability to filter accounting information might be limited to only use with certain specified accounting servers in order to avoid a risk that important accounting information might be forwarded and stored with insufficient redundancy.

We claim:

1. A method comprising:
at a network element:
receiving data intended for another destination;
developing accounting information corresponding to the data;
processing the accounting information with respect to at least one filter criterion as correlates to a target accounting information recipient to provide filtered accounting information;
forwarding the filtered accounting information to the target accounting information recipient.

2. The method of claim 1 wherein the network element comprises at least one of:
a packet data serving node;
a wireless home agent;
a gateway general packet radio service support node;
an 802.11-family compatible access gateway;
a digital subscriber line access multiplier;
a remote access server.

3. The method of claim 1 wherein receiving data for another destination comprises receiving data packets.

4. The method of claim 1 wherein processing the accounting information with respect to at least one filter criterion as correlates to a target accounting information recipient to provide filtered accounting information comprises processing the accounting information with respect to at least one of:
a Network Access Identifier as corresponds to a source of the data;
a Network Access Identifier as corresponds to the another destination;
a domain identifier;
an International Mobile Station Identity;
an Electronic Serial Number;
a Mobile Equipment IDentifier;
a client device Internet Protocol address;
a Home Agent Internet Protocol address;
a Packet Control Function Internet Protocol address;
a base station identifier;
a service option;
a quality of service indicator.

5. The method of claim 1 wherein processing the accounting information with respect to at least one filter criterion as correlates to a target accounting information recipient to provide filtered accounting information comprises processing the accounting information with respect to a plurality of filter criteria as correlates to the target accounting information recipient.

6. The method of claim 1 further comprising:
forwarding the accounting information without filtering to another accounting information recipient other than the target accounting information recipient.

7. The method of claim 1 wherein processing the accounting information with respect to at least one filter criterion as correlates to a target accounting information recipient to provide filtered accounting information further comprises:
processing the accounting information with respect to at least one first filter criterion as correlates to a first target accounting information recipient to provide first filtered accounting information;
processing the accounting information with respect to at least one second filter criterion as correlates to a second target accounting information recipient to provide second filtered accounting information.

8. The method of claim 7 wherein forwarding the filtered accounting information to the target accounting information recipient further comprises:
forwarding the first filtered accounting information to the first target accounting information recipient;
forwarding the second filtered accounting information to the second target accounting information recipient.

9. A network element comprising:
an incoming data interface;
a first memory operably coupled to the incoming data interface and having received data intended for another destination stored therein;
a data forwarder operably coupled to the memory;
a second memory having accounting information as corresponds to the received data stored therein;
a third memory having at least one accounting information filter criterion stored therein;
a fourth memory having filtered accounting information stored therein, which filtered accounting information comprises the accounting information as filtered with respect to the at least one accounting information filter criterion;
an accounting information recipient forwarding interface operably coupled to the fourth memory.

10. The network element of claim 9 wherein the network element comprises at least one of:
a packet data serving node;
a wireless home agent;
a gateway general packet radio service support node;
an 802.11-family compatible access gateway;
a digital subscriber line access multiplier;
a remote access server.

11. The network element of claim 9 wherein the received data comprises received data packets.

12. The network element of claim 9 wherein the least one accounting information filter criterion corresponds to at least one of:
a Network Access Identifier as corresponds to a source of the data;
a Network Access Identifier as corresponds to the another destination;
a domain identifier;
an International Mobile Station Identity;
an Electronic Serial Number;
a Mobile Equipment IDentifier;
a client device Internet Protocol address;
a Home Agent Internet Protocol address;
a Packet Control Function Internet Protocol address;
a base station identifier;
a service option;
a quality of service indicator.

13. The network element of claim 9 further comprising means operably coupled to the second, third, and fourth memory for processing the accounting information with respect to the at least one filter criterion to provide filtered accounting information

14. The network element of claim 13 wherein the means for processing the accounting information further comprises means for processing the accounting information with respect to a plurality of filter criteria as correlates to a target accounting information recipient.

15. The network element of claim 9 wherein the third memory has stored therein:
a first at least one accounting information filter criterion as corresponds to a first target accounting information recipient;
a second at least one accounting information filter criterion as corresponds to a second target accounting information recipient that is different than the first target accounting information recipient.

16. The network element of claim 15 further comprising a filter operably coupled to the second, third, and fourth memory and being configured and arranged to:
process the accounting information with respect to the first at least one filter criterion to provide first filtered accounting information;
process the accounting information with respect to the second at least one filter criterion to provide second filtered accounting information.

17. The network element of claim 16 wherein the accounting information recipient forwarding interface is configured and arranged to:
forward the first filtered accounting information to the first target accounting information recipient;
forward the second filtered accounting information to the second target accounting information recipient.

18. A method comprising: at a network element that is coupled to at least a first accounting information recipient and a second accounting information recipient:
receiving data intended for another destination;
developing accounting information corresponding to the data;
providing the accounting information to the first accounting information recipient such that the first accounting information recipient has a substantially complete record of network element-based accounting information;
processing the accounting information with respect to at least one filter criterion as correlates to a target accounting information recipient to provide filtered accounting information;
forwarding the filtered accounting information to the second accounting information recipient such that the second accounting information recipient has a substantially incomplete record of network element-based accounting information;
forwarding the data to the another destination;
at the first accounting information recipient:
receiving the accounting information;
storing the accounting information;
at the second accounting information recipient:
receiving the filtered accounting information;
storing the filtered accounting information.

19. The method of claim 18 wherein processing the accounting information with respect to at least one filter criterion as correlates to a target accounting information recipient to provide filtered accounting information comprises processing the accounting information with respect to a plurality of filter criteria as correlates to the target accounting information recipient.

20. The method of claim 18 wherein processing the accounting information with respect to at least one filter criterion as correlates to a target accounting information recipient to provide filtered accounting information comprises processing the accounting information with respect to at least one of:
a Network Access Identifier as corresponds to a source of the data;
a Network Access Identifier as corresponds to the another destination;
a domain identifier;
an International Mobile Station Identity;
an Electronic Serial Number;
a Mobile Equipment IDentifier;
a client device Internet Protocol address;
a Home Agent Internet Protocol address;
a Packet Control Function Internet Protocol address;
a base station identifier;
a service option;
a quality of service indicator.
